(19) United States
(12) Patent Application Publication
(10) Pub. No.: US 2017/0083495 A1
(43) Pub. Date: Mar. 23, 2017

(54) Method for Modifying Webpage and Apparatus for Modifying Webpage

(71) Applicant: TENCENT TECHNOLOGY (SHENZHEN) COMPANY LIMITED, Shenzhen (CN)

(72) Inventor: Bo Wan, Shenzhen (CN)

(21) Appl. No.: 15/335,732

(22) PCT Filed: Apr. 29, 2015
(86) PCT No.: PCT/CN2015/077886

§ 371 Date: Oct. 27, 2016

(30) Foreign Application Priority Data
Apr. 29, 2014 (CN) 201410177993.X

(51) Int. Cl. G06F 17/24; G06F 17/22; H04L 29/06; G06F 17/27

(52) U.S. Cl. CPC G06F 17/24; G06F 17/2705; G06F 17/2247; H04L 63/08; H04L 67/02

(57) ABSTRACT

The present disclosure provides a method for modifying a webpage and an apparatus for modifying a webpage. The method for modifying a webpage includes: acquiring source code of a current webpage from a web server according to a webpage activation instruction; parsing the source code of the current webpage, to acquire modifiable objects of the current webpage; modifying, according to a webpage modification instruction, a modifiable object, corresponding to the webpage modification instruction, of the current webpage; and modifying the source code of the current webpage according to an end-of-modification instruction by using the webpage object after the modification of the current webpage. The present disclosure further provides the apparatus for modifying a webpage. In the method for modifying a webpage and the apparatus for modifying a webpage of the present disclosure, source code of a webpage is converted into a webpage object, thereby implementing a visual modification for a webpage.

### FIELD OF THE TECHNOLOGY

The present disclosure relates to the field of Internet, and in particular, to a method for modifying a webpage and an apparatus for modifying a webpage.

### BACKGROUND OF THE DISCLOSURE

With rapid development of mobile internet technologies, webpage information is updated at an increasing speed, to meet increasing information requirements of users.

At present, a webpage modification staff modifies a webpage generally by modifying source code of a webpage file manually, or modifying source code of a webpage file by using a visual modifier. After the modification is finished, the webpage file after the modification is uploaded to a web server by using an upload tool, for example, File Transfer Protocol (FTP) software, so as to implement modification of a webpage.

However, in the foregoing method for modifying a webpage, a webpage modification staff needs to search for a modification position artificially according to content to be modified, modify a webpage, and perform upload processing on a webpage file after the modification, leading to a slow speed of a webpage modification, thereby severely affecting efficiency of modifying a webpage file. To implement that all source code in a webpage file can be modified, in an existing visual modifier, a visual effect of the webpage file may be different from a display effect that the webpage file finally shows in a browser, and a certain technical threshold is needed for a modification staff; therefore, an appointed person is needed to perform a modification operation on the webpage, and efficiency of modifying the webpage is also low.

### SUMMARY

Embodiments of the present invention provide a method for modifying a webpage, which can efficiently modify a webpage, so as to solve technical problems such as low efficiency of a modification operation and modification processing in an existing method for modifying a webpage.

Embodiments of the present invention further provide an apparatus for modifying a webpage, which can efficiently modify a webpage, so as to solve technical problems such as low efficiency of a modification operation and modification processing in an existing apparatus for modifying a webpage.

In order to solve the foregoing problems, the technical solutions provided in the present disclosure are as follows:

An embodiment of the present invention further provides a method for modifying a webpage, including:

receiving a webpage activation instruction, and acquiring source code of a current webpage from a web server according to the webpage activation instruction;

parsing the source code of the current webpage, and acquiring and displaying webpage objects of the current webpage, the webpage objects comprising modifiable objects;

receiving a webpage modification instruction, and modifying a modifiable object of the current webpage according to the webpage modification instruction, the modifiable object of the current webpage corresponding to the webpage modification instruction; and

receiving an end-of-modification instruction, and modifying the source code of the current webpage according to the end-of-modification instruction by using the modifiable object after the modification.

An embodiment of the present invention further provides an apparatus for modifying a webpage, including:

a source code acquisition module, configured to receive a webpage activation instruction, and acquire source code of a current webpage from a web server according to the webpage activation instruction;

a webpage parsing module, configured to parse the source code of the current webpage, and acquire and display webpage objects of the current webpage, the webpage objects including modifiable objects;

a webpage modification module, configured to receive a webpage modification instruction, and modify a modifiable object of the current webpage according to the webpage modification instruction, the modifiable object of the current webpage corresponding to the webpage modification instruction; and

a source code modification module, configured to receive an end-of-modification instruction, and modify the source code of the current webpage according to the end-of-modification instruction by using the modifiable object after the modification of the current webpage.

Relative to a method for modifying a webpage and an apparatus for modifying a webpage in an existing technology, the method for modifying a webpage and the apparatus for modifying a webpage of the present disclosure convert source code of a webpage into a webpage object, thereby implementing a visual modification for a webpage; and solving technical problems such as low efficiency of a modification operation and modification processing in an existing apparatus for modifying a webpage and an existing method for modifying a webpage.

### BRIEF DESCRIPTION OF THE DRAWINGS

FIG. 1 is a schematic structural diagram of a working environment of an electronic device in which an apparatus for modifying a webpage is located according to the present disclosure;

FIG. 2 is a schematic structural diagram of a first preferred embodiment of an apparatus for modifying a webpage according to the present disclosure;

FIG. 3 is a flowchart of a first preferred embodiment of a method for modifying a webpage according to the present disclosure;

FIG. 4 is a schematic structural diagram of a second preferred embodiment of an apparatus for modifying a webpage according to the present disclosure;

FIG. 5 is a schematic structural diagram of a source code acquisition module of the second preferred embodiment of the apparatus for modifying a webpage according to the present disclosure;

FIG. 6 is a schematic structural diagram of a webpage modification module of the second preferred embodiment of the apparatus for modifying a webpage according to the present disclosure;

FIG. 7 is a schematic structural diagram of a webpage modification unit of the webpage modification module of the second preferred embodiment of the apparatus for modifying a webpage according to the present disclosure;

FIG. 8 is a schematic structural diagram of a source code modification module of the second preferred embodiment of the apparatus for modifying a webpage according to the present disclosure;

FIG. 9 is a flowchart of a second preferred embodiment of a method for modifying a webpage according to the present disclosure;

FIG. 10 is a specific flowchart of step S901 in the second preferred embodiment of the method for modifying a webpage according to the present disclosure;

FIG. 11 is a specific flowchart of step S903 in the second preferred embodiment of the method for modifying a webpage according to the present disclosure;

FIG. 12 is a specific flowchart of step S904 in the second preferred embodiment of the method for modifying a webpage according to the present disclosure; and

FIG. 13A-FIG. 13J are schematic diagram of usage of a method for modifying a webpage and an apparatus for modifying a webpage according to the present disclosure.

### DESCRIPTION OF EMBODIMENTS

Refer to the drawings, a same component symbol represents a same component, and a principle of the present disclosure is described by using that the present disclosure is executed in a suitable operating environment an example. The following description is based on specific embodiments of the present invention that are shown as examples, and should not be regarded as a limitation to another specific embodiment that is not described herein in detail in the preset disclosure.

In the following description, the specific embodiments of the present disclosure are described with reference to steps and symbols of jobs that are executed by one or more computers, unless otherwise specified. Therefore, it may be understood that, that these steps and operations are “executed by a computer” is mentioned several times, which includes that these steps and operations are manipulated by a computer processing unit that represents an electronic signal of data in a structured type. The data is converted or maintained in a position of a memory system of the computer by means of this manipulation, and this manipulation may be reconfigured or running of the computer is changed in a manner well known by a person skilled in the art. A data structure maintained by the data is a physical position of the memory, and the data structure has a particular characteristic that is defined by a format of the data. However, the principle of the present disclosure is described by using the foregoing text, which does not represent a limitation, and it may be understood by a person skilled in the art that multiple steps and operations described below may also be implemented in hardware.

For example, the terms such as “component”, “module”, “system”, “interface”, “process” used in this application are generally intended to refer to entities: hardware, combination of hardware and software, and software, or software during execution, that are related to a computer. For example, the component may be, but is not limited to, a process running on a processor, a processor, an object, an executable application, an executed thread, a program, and/or a computer. By using the drawings, both of an application running on a controller and the controller component can be components. One or more components may be in an executed process and/or thread, and the components may be located on one computer and/or distributed between two computers or among more computers.

Moreover, a subject claimed to be protected may be implemented by software, firmware, hardware, or any combination of them that are generated by using standard programming and/or engineering technologies, so as to control a computer to implement a method, an apparatus, or a product of the disclosed subject. The term “product” used in this specification is intended to include a computer program that can be accessed from any computer readable device, carrier, and medium. Certainly, it should be recognized by a person skilled in the art that many modifications may be performed on the configuration without departing from the scope and spirits of the subject claimed to be protected.

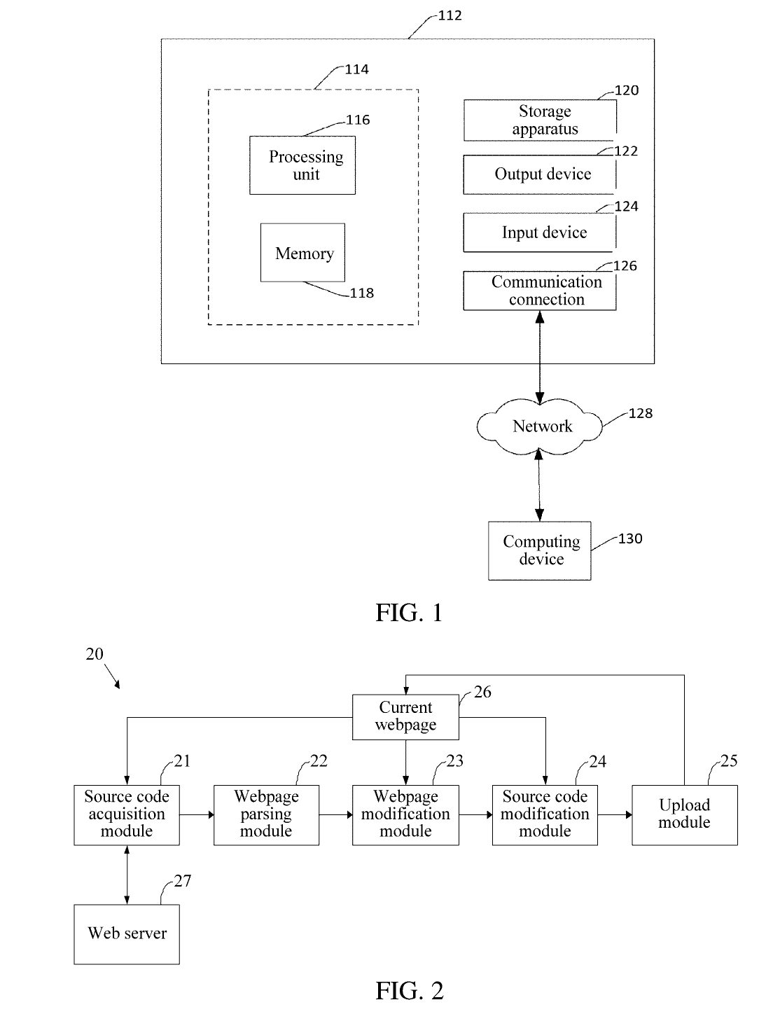

FIG. 1 and a subsequent discussion provide a brief and general description for a working environment of an electronic device in which an apparatus for modifying a webpage that is described in the present invention is implemented and located. The working environment of FIG. 1 is only an example of a suitable working environment, but is not intended to give a suggestion about any limitation to scopes of purposes and functions of the working environment. An example electronic device 112 includes, but is not limited to, a personal computer, a server computer, a handheld or laptop device, a mobile device (for example, a mobile phone, a personal digital assistant (PDA), a media player, or the like), a multiprocessor system, a consumer electronic device, a small computer, a large computer, a distributed computing environment including any one of the foregoing systems or devices, and the like.

Although not required, the embodiments are described under a common background that “computer readable instructions” are executed by one or more electronic devices. The computer readable instructions may be distributed by using a computer readable medium (which is discussed below). The computer readable instruction may be implemented as a program module, such as a function, an object, an application programming interface (API), and a data structure that execute a particular task or implement a particular abstract data type. Typically, functions of the computer readable instruction may be arbitrarily combined or distributed in various environments.

FIG. 1 shows the example of the electronic device 112 of one or more embodiments including apparatus for modifying a webpage of the present disclosure. In a configuration, the electronic device 112 includes at least one processing unit 116 and a memory 118. According to an exact configuration and type of the electronic device, the memory 118 may be a volatile memory, (for example, a random access memory (RAM)), a non-volatile memory (such as a read-only memory (ROM) and a flash memory), or a combination of the two. The configuration is shown by using a dotted line 114 in FIG. 1.

In another embodiment, the electronic device 112 may include an additional feature and/or function. For example, the device 112 may further include an additional storage apparatus (for example, a removable and/or non-removable storage apparatus), which includes, but is not limited to, a magnetic storage apparatus, an optical storage apparatus, and the like. Such an additional storage apparatus is shown as a storage apparatus 120 in FIG. 1. In an embodiment, the computer readable instructions for implementing the one or more embodiments provided in this specification may be in the storage apparatus 120. The storage apparatus 120 may further store another computer readable instruction used for implementing an operating system, and an application program. The computer readable instructions may be loaded into the memory 118 for being executed by the processing unit 116, for example.

The term “computer readable medium” used in this specification includes a computer storage medium. The computer storage medium includes volatile and non-volatile media and removable and non-removable media that are implemented by any method or technology for storing a computer readable instruction or another piece of information such as data. The memory 118 and the storage apparatus 120 are examples of the computer storage medium. The computer storage medium includes, but is not limited to, an RAM, an ROM, an electrically erasable programmable read-only memory (EEPROM), a flash memory, or another memory technology, a compact disc read-only memory (CD-ROM), a digital versatile disc (DVD), or another optical storage apparatus, a tape cartridge, a magnetic tape, a disk storage apparatus, or another magnetic store device, or any other medium that can be configured to store expected information and be accessed by the electronic device 112. Such an arbitrary computer storage medium may be a part of the electronic device 112.

The electronic device 112 may further include a communication connection 126 allowing the electronic device 112 to communicate with another device. The communication connection 126 may include, but is not limited to, a modem, a network interface card (NIC), an integrated network interface, a radio frequency transmitter/receiver, an infrared port, a universal serial bus (USB) connection interface, or another interface configured to connect the electronic device 112 and another electronic device. The communication connection 126 may include a wired connection or a wireless connection. The communication connection 126 may transmit and/or receive a communication medium.

The term “computer readable medium” may include a communication medium. The communication medium typically includes a computer readable instruction or another piece of data in a “modulated data signal” such as a carrier or another transmission mechanism, and includes any information delivery medium. The term “modulated data signal” may include such a signal: where one or more characteristics of the signal are set or changed according to a manner of encoding information into the signal.

The electronic device 112 may include an input device 124, for example, a keyboard, a mouse, a voice input device, a touch input device, an infrared camera, a video input device, and/or any other input device. The device 112 may also include an output device 122, for example, a display, a loudspeaker, a printer, and/or any other output device. The input device 124 and the output device 122 may be connected to the connection electronic device 112 by using the wired connection, the wireless connection, or any combination of them. In an embodiment, an input device or an output device from another electronic device may be used as the input device 124 or the output device 122 of the electronic device 112.

Components of the electronic device 112 may be connected by various interconnections (for example a bus). Such interconnections may include a structure such as a peripheral component interconnection (PCI) (for example, a fast PCI), a universal serial bus (USB), a live wire (IEEE 1394), and an optical bus. In another embodiment, components of the electronic device 112 may be interconnected by using a network. For example, the memory 118 may include multiple physical memory units that are located at different physical positions and interconnected by using a network.

It should be recognized by a person skilled in the art that storage devices configured to store a computer readable instruction may be distributed across a network. For example, a computing device 130 that can be accessed by using a network 128 may store the computer readable instructions of the provided one or more embodiments used for implementing the present disclosure. The electronic device 112 may access the electronic device 130 and download some or all of the computer readable instructions for execution. Alternatively, the electronic device 112 may download multiple computer readable instructions as needed, or some instructions may be executed at the electronic device 112 and some instructions may be executed at the electronic device 130.

Various operations of the embodiments are provided in this specification. In an embodiment, the one or more operations may constitute computer readable instructions stored on one or more computer readable media, and when the computer readable instruction is executed by an electronic device, the operation is executed by a computing device. A sequence of describing some or all of the operations should not be explained to indicate that these operations must be sequentially related. An alternative sequence having the advantages of this specification should be understood by a person skilled in the art. Moreover, it should be understood that not all the operations must exist in each embodiment provided in this specification.

Moreover, the word “preferably” used in this specification means “used as an example, instance or exemplification”. Any aspect or design described as “preferably” in this specification is not necessarily explained as being better than another aspect or design. Instead, use of the word “preferably” is intended to provide a concept in a specific manner. The terms “or” used in this application is intended to mean “or” indicating “including” rather than “or” indicating “excluding”. That is, unless otherwise specified or the context clearly indicates otherwise, “A or B is used by X” means that either one arranged is naturally included. That is, if A is used by X; B is used by X; or both of A and b are used by X, “A or B is used by X” is satisfied in any one of the foregoing instances.

Moreover, although the present disclosure is shown and described relative to one or more implementation manner, equivalent variations and modifications should be figured out by a person skilled in the art based on reading and understanding of this specification and the accompanying drawings. The present disclosure includes all such modifications and variations, and is limited only by the scope of the appended claims. Particularly, for various functions executed by the foregoing components (for example, an element, a resource, and the like), the terms used for describing such components are intended to correspond to any components (unless indicated otherwise) executing specified functions (for example, they are functionally equivalent) of the components, even if structures of the any components are different from disclosed structures of the functions in the shown exemplary implementation manners, which executes this specification, of the present disclosure. In addition, although a particular feature of the present disclosure is disclosed in one implementation manner relative to several implementation manners, such a feature may be combined with one or more other features of other implementation manners that are expected by or beneficial to a given or particular application. Moreover, for the terms “include”, “have”, “contain” or variations of them that are used in the specific implementation manners or the claims, such terms are intended to include in a manner similar to the term “contain”.

Refer to FIG. 2, FIG. 2 is a schematic structural diagram of a first preferred embodiment of an apparatus for modifying a webpage according to the present disclosure. An apparatus 20 for modifying a webpage of this preferred embodiment may be disposed in the foregoing electronic device 112, and the apparatus 20 for modifying a webpage includes a source code acquisition module 21, a webpage parsing module 22, a webpage modification module 23, and a source code modification module 24. The source code acquisition module 21 is configured to receive a webpage activation instruction, and acquire source code of a current webpage 26 from a web server 27 according to the webpage activation instruction; the webpage parsing module 22 is configured to parse the source code of the current webpage 26, and acquire webpage objects of the current webpage 26; the webpage modification module 23 is configured to receive a webpage modification instruction, and modify a webpage object, corresponding to the webpage modification instruction, of the current webpage 26 according to the webpage modification instruction; and the source code modification module 24 is configured to receive an end-of-modification instruction, and modify the source code of the current webpage 26 according to the end-of-modification instruction by using the webpage object after the modification of the current webpage 26.

When the apparatus 20 for modifying a webpage of this preferred embodiment is used, at first, the source code acquisition module 21 receives the webpage activation instruction, where the webpage activation instruction may be a button instruction on a browser, which is used for indicating that a user wants to modify the current webpage 26; and in this case, the source code acquisition module 21 acquires the source code of the current webpage 26 from the web server 27 according to the webpage activation instruction, for modifying the source code of the current webpage 26.

Then, the webpage parsing module 22 parses the source code, which is acquired by the source code acquisition module 21, of the current webpage 26, and acquires the webpage objects of the current webpage 26. If the source code of the current webpage 26 is parsed into a document object model (DOM) tree, the webpage objects of the current webpage 26 are element objects (or nodes) on the DOM tree. The parsed webpage objects of the current webpage 26 may be viewed by a user in a visual manner.

Subsequently, the webpage modification module 23 receives the webpage modification instruction, and the webpage modification instruction may be an instruction that the user modifies an element object of the DOM tree by using the browser, for example, a setting parameter such as content, a color, and a font of the element object is modified. The webpage modification module 23 may modify the webpage object, corresponding to the webpage modification instruction, of the current webpage 26 according to the webpage modification instruction.

Finally, the source code modification module 24 receives the end-of-modification instruction, and the end-of-modification instruction is used for indicating that the user has already completed the modification of the webpage object of the current webpage 26. In this case, the webpage modification module 23 modifies the source code of the current webpage 26 according to the end-of-modification instruction by using the webpage object after the modification of the current webpage 26 (that is, an element object after the modification of the DOM tree).

In this way, a process of modifying the webpage by the apparatus 20 for modifying a webpage of this preferred embodiment is completed.

Preferably, the apparatus 20 for modifying a webpage of this preferred embodiment may further include an upload module 25, where the upload module 25 is configured to upload the source code after the modification of the current webpage 26 to the web server 27, and overwriting may be performed on the source code before the modification of the current webpage 26 if a manager agrees.

The apparatus for modifying a webpage of this preferred embodiment converts source code of a webpage into a webpage object of the webpage, thereby implementing a visual modification for a webpage, and improving processing efficiency of a webpage modification operation.

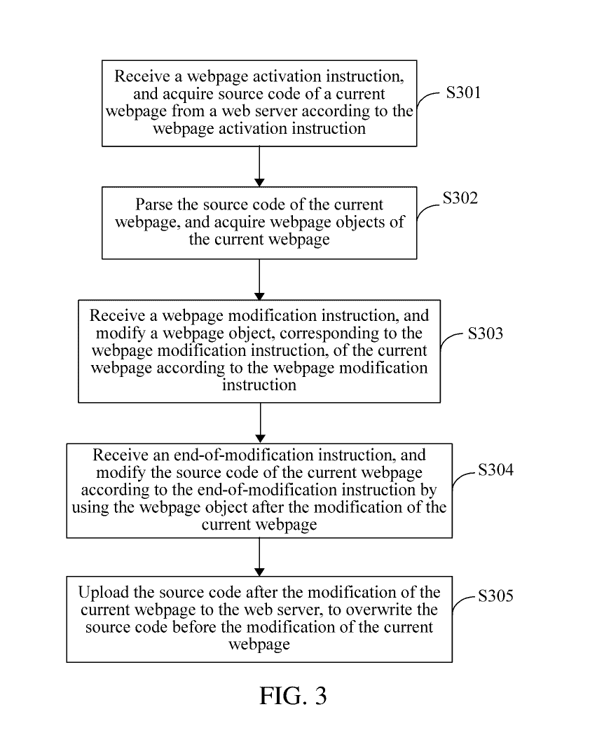

Refer to FIG. 3, FIG. 3 is a flowchart of a first preferred embodiment of a method for modifying a webpage according to the present disclosure. The method for modifying a webpage of this preferred embodiment may be executed by using the first preferred embodiment of the foregoing apparatus 20 for modifying a webpage, and the method for modifying a webpage includes:

Step S301: Receive a webpage activation instruction, and acquire source code of a current webpage from a web server according to the webpage activation instruction.

Step S302: Parse the source code of the current webpage, and acquire webpage objects of the current webpage.

Step S303: Receive a webpage modification instruction, and modify a webpage object, corresponding to the webpage modification instruction, of the current webpage according to the webpage modification instruction.

Step S304: Receive an end-of-modification instruction, and modify the source code of the current webpage according to the end-of-modification instruction by using the webpage object after the modification of the current webpage.

The method for modifying a webpage of this preferred embodiment ends with step S304.

Specific procedures of steps in the method for modifying a webpage of this preferred embodiment are described in detail below.

In step S301, a source code acquisition module 21 receives a webpage activation instruction, where the webpage activation instruction may be a button instruction on a browser, which is used for indicating that a user wants to modify a current webpage 26; and in this case, a source code acquisition module 21 acquires source code of the current webpage 26 from a web server 27 according to the webpage activation instruction, for modifying the source code of the current webpage 26. Subsequently, go to step S302.

In step S302, a webpage parsing module 22 parses the source code, which is acquired by the source code acquisition module 21, of the current webpage 26, and acquires webpage objects of the current webpage 26. If the source code of the current webpage 26 is parsed into a DOM tree, the webpage objects of the current webpage 26 are element objects (or nodes) on the DOM tree. The parsed webpage objects of the current webpage 26 may be viewed by a user in a visual manner. Subsequently, go to step S303.

In step S303, Subsequently, a webpage modification module 23 receives a webpage modification instruction, and the webpage modification instruction may be an instruction that the user modifies an element object of the DOM tree by using the browser, for example, a setting parameter such as content, a color, and a font of the element object is modified. The webpage modification module 23 may modify a webpage object, corresponding to the webpage modification instruction, of the current webpage 26 according to the webpage modification instruction. Subsequently, go to step S304.

In step S304, a source code modification module 24 receives an end-of-modification instruction, and the end-of-modification instruction is used for indicating that the user has already completed the modification of the webpage object of the current webpage 26. In this case, the webpage modification module 23 modifies the source code of the current webpage 26 according to the end-of-modification instruction by using the webpage object after the modification of the current webpage 26 (that is, an element object after the modification of the DOM tree).

In this way, a process of modifying the webpage in the method for modifying a webpage of this preferred embodiment is completed.

Preferably, the method for modifying a webpage of this preferred embodiment may further include:

Step S305. Upload the source code after the modification of the current webpage to the web server, to overwrite the source code before the modification of the current webpage.

In step S305, an upload module 25 of the apparatus 20 for modifying a webpage uploads the source code after the modification of the current webpage 26 to the web server 27, and overwriting may be performed on the source code before the modification of the current webpage 26 if a manager agrees.

In the method for modifying a webpage of this preferred embodiment, source code of a webpage is converted into a webpage object of the webpage, thereby implementing a visual modification for a webpage, and improving processing efficiency of a webpage modification operation.

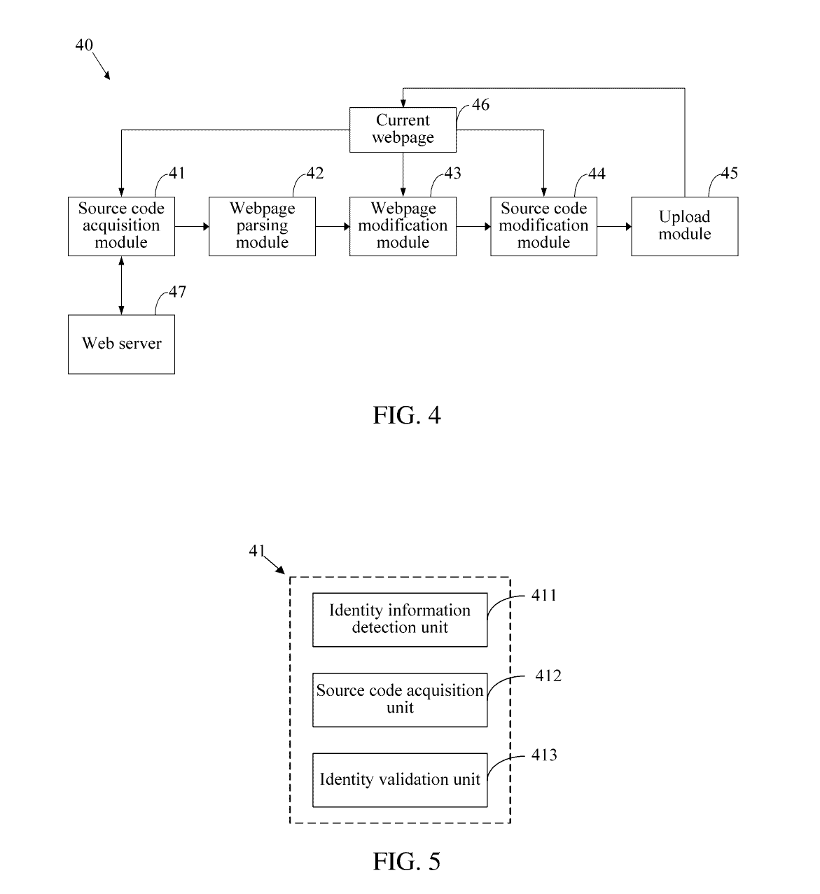

Refer to FIG. 4, FIG. 4 is a schematic structural diagram of a second preferred embodiment of an apparatus for modifying a webpage according to the present disclosure. An apparatus 40 for modifying a webpage of this preferred embodiment may be disposed in the foregoing electronic device 112, and the apparatus 20 for modifying a webpage includes a source code acquisition module 41, a webpage parsing module 42, a webpage modification module 43, a source code modification module 44, and an upload module 45.

Refer to FIG. 5, FIG. 5 is a schematic structural diagram of the source code acquisition module in the second preferred embodiment of the apparatus for modifying a webpage according to the present disclosure. A difference between this preferred embodiment and the first preferred embodiment lies in that the source code acquisition module 41 includes an identity information detection unit 411, a source code acquisition unit 412, and an identity validation unit 413. The identity information detection unit 411 is configured to detect whether identity validation information is received; and the source code acquisition unit 412 is configured to acquire source code of a current webpage 46 from a web server 47; and the identity validation unit 413 is configured to perform an identity validation operation. The identity validation information herein may be login account information, on a client, of a user, and security of a webpage modification operation may be ensured by verification of the identity validation information.

A webpage modification instruction includes an object selection sub instruction and a parameter modification sub instruction, where the object selection sub instruction is used for an operation of selecting, by a user, a webpage object to be modified, and the parameter modification sub instruction is used for an operation of modifying, by the user, the webpage object to be modified.

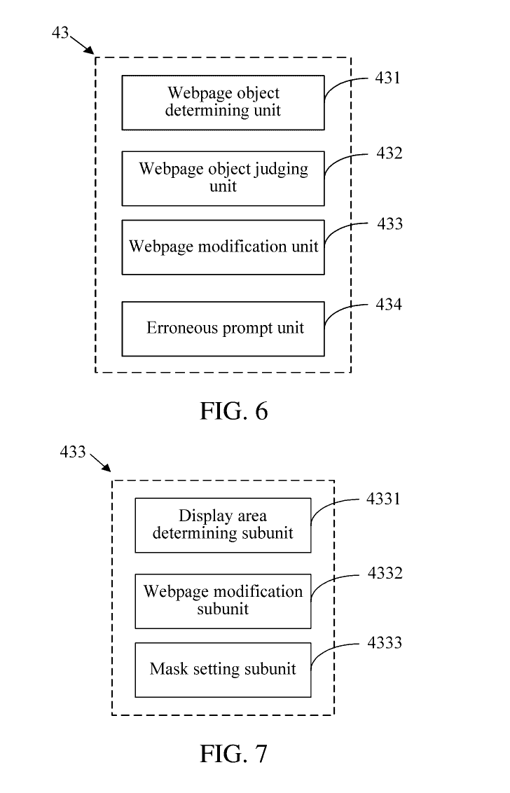

Refer to FIG. 6, FIG. 6 is a schematic structural diagram of the webpage modification module in the second preferred embodiment of the apparatus for modifying a webpage according to the present disclosure. A difference between this preferred embodiment and the first preferred embodiment lies in that the webpage modification module 43 includes a webpage object determining unit 431, a webpage object judging unit 432, a webpage modification unit 433, and an erroneous prompt unit 434. The webpage object determining unit 431 is configured to determine, according to the object selection sub instruction, a webpage object, corresponding to a webpage modification instruction, of a current webpage 46; the webpage object judging unit 432 is configured to judge whether the webpage object, corresponding to the webpage modification instruction, of the current webpage is a modifiable object according to a name and an attribute of the webpage object of the current webpage 46; the webpage modification unit 433 is configured to modify a parameter of the modifiable object according to the parameter modification sub instruction; and an erroneous prompt unit 434 is configured to prompt that a modification is erroneous. The name and the attribute herein of the webpage object may be a name and an attribute of an element object on a DOM tree. The modifiable object is an element object that can be modified by a user by using a webpage modification unit, and names and attributes of object elements may be artificially set to determine corresponding modifiable objects. If the user selects to modify a non-modifiable object, the erroneous prompt unit 434 prompts that the modification is erroneous.

Refer to FIG. 7, FIG. 7 is a schematic structural diagram of the webpage modification unit of the webpage modification module in the second preferred embodiment of the apparatus for modifying a webpage according to the present disclosure. The webpage modification unit 433 includes a display area determining subunit 4331, a webpage modification subunit 4332, and a mask setting subunit 4333. The display area determining subunit 4331 is configured to determine a display area of the modifiable object; the webpage modification subunit 4332 is configured to modify, in the display area of the modifiable object, the parameter of the modifiable object according to the parameter modification sub instruction; and the mask setting subunit 4333 is configured to setting a mask in a non-display area of the modifiable object, to avoid modifying a parameter of another webpage object. The mask covers or masks the non-display area of the modifiable object to be modified, to distinguish the display area of the modifiable object from the non-display area of the modifiable object.

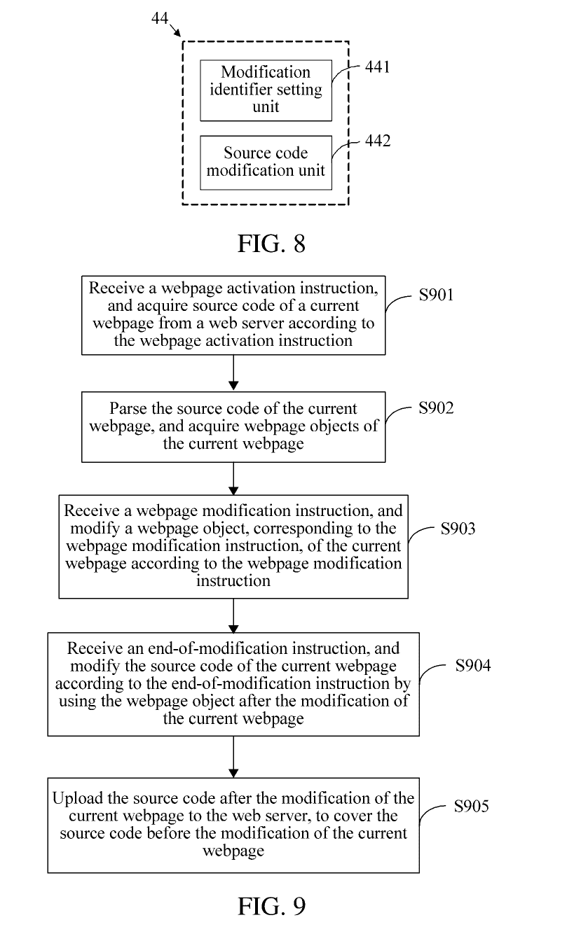

Refer to FIG. 8, FIG. 8 is a schematic structural diagram of the source code modification module of the second preferred embodiment of the apparatus for modifying a webpage according to the present disclosure. The source code modification module 44 includes a modification identifier setting unit 441 and a source code modification unit 442, where the modification identifier setting unit 441 is configured to set a modification identifier for the webpage object after the modification of the current webpage 46; and the source code modification unit 442 is configured to modify the source code of the current webpage 46 according to the modification identifier by using the webpage object after the modification of the current webpage 46. The modification identifier herein is used for distinguishing all webpage objects after the modification of the current webpage 46, to avoid occurrence of an error when the source code of the current webpage 46 is modified by using the webpage object after the modification of the current webpage 46.

When the apparatus 40 for modifying a webpage of this preferred embodiment is used, at first, the source code acquisition module 41 receives a webpage activation instruction, and acquires the source code of the current webpage from the web server 47 according to the webpage activation instruction, which specifically may be that when the source code acquisition module 41 receives the webpage activation instruction, the identity information detection unit 411 of the source code acquisition module 41 detects whether the client receives the identity validation information input by the user. If the identity information detection unit 411 acquires the identity validation information (for example, login account information, where the login account information has a permission for modifying a webpage) of the user, the source code acquisition unit 412 of the source code acquisition module 41 acquires source code of the current webpage 46 from the web server 47, to modify the source code of the current webpage 46; or if the identity information detection unit 411 does not acquire the identity validation information of the user, the identity validation unit 413 of the source code acquisition module 41 performs the identity validation operation, for example, a user login interface pops up to prompt the user to input the identity validation information.

Then, the webpage parsing module 42 parses the source code, which is acquired by the source code acquisition module 41, of the current webpage 46, and acquires webpage objects of the current webpage 46. If the source code of the current webpage 46 is parsed into a DOM tree, the webpage objects of the current webpage 46 are element objects (or nodes) on the DOM tree. The parsed webpage objects of the current webpage 46 may be viewed by a user in a visual manner.

Subsequently, the webpage modification module 43 receives the webpage modification instruction, and modifies the webpage object, corresponding to the webpage modification instruction, of the current webpage 46 according to the webpage modification instruction, which specifically may be that:

When the webpage modification module 43 receives the webpage modification instruction, the webpage object determining unit 431 of the webpage modification module 43 determines, according to the object selection sub instruction in the webpage modification instruction, the webpage object (for example, an element object of the DOM tree), corresponding to the webpage modification instruction, of the current webpage 46. The webpage object judging unit 432 judges whether the webpage object, corresponding to the webpage modification instruction, of the current webpage 46 is a modifiable object according to the name and the attribute of the webpage object of the current webpage 46. For example, the user may set that an element object whose name is A or B and attribute is inline-block is a modifiable object, or the like. If the webpage object selected by the user is a modifiable object, the webpage modification unit 433 modifies the parameter of the modifiable object according to the parameter modification sub instruction in the webpage modification instruction, and the parameter of the modifiable object may be a setting parameter such as content, a color, and a font of the modifiable object. If the webpage object selected by the user is not a modifiable object, the erroneous prompt unit 434 prompts that a modification is erroneous, to inform the user that the webpage object is unmodifiable.

Preferably, herein, the modifying, by the webpage modification unit 433, a parameter of the modifiable object according to the parameter modification sub instruction may specifically be that: the display area determining subunit 4331 of the webpage modification unit 433 determines the display area of the modifiable object, and the webpage modification subunit 4332 of the webpage modification unit 433 modifies, in the display area of the modifiable object, the parameter of the modifiable object according to the parameter modification sub instruction. Because the display area determining subunit 4332 displays a modification range, availability of modification is further improved, so that the user is prevented from modifying out of the range easily. The mask setting subunit 4333 of the webpage modification unit 433 sets the mask in the non-display area of the modifiable object, to avoid erroneously modifying a parameter of another webpage object.

Finally, the source code modification module 44 receives the end-of-modification instruction, and the end-of-modification instruction is used for indicating that the user has already completed the modification of the webpage object of the current webpage 46. Specifically, the modification identifier setting unit 441 of the source code modification module 44 sets the modification identifier for the webpage object after the modification of the current webpage 46 (for example, regular expressions are generated for all the webpage objects after the modification of the current webpage 46), to distinguish all the webpage objects after the modification of the current webpage 46. In this way, a modification error does not occur even if webpage objects having same content are modified. After the setting of the modification identifier is finished, the source code modification unit 442 of the source code modification module 44 modifies, by using the webpage object after the modification of the current webpage 26, the source code of the current webpage 26 according to the modification identifier set by the modification identifier setting unit 441.

In this way, a process of modifying the webpage by the apparatus 40 for modifying a webpage of this preferred embodiment is completed.

Preferably, the apparatus 40 for modifying a webpage of this preferred embodiment may further include the upload module 45, where the upload module 45 is configured to upload the source code after the modification of the current webpage 46 to the web server 47, and overwriting may be performed on the source code before the modification of the current webpage 46 if a manager agrees.

The detecting of identity information is added, based on the first preferred embodiment, in the apparatus for modifying a webpage of this preferred embodiment, so that a process of modifying a webpage is optimized, and a modification identifier is set, so that processing efficiency of a webpage modification operation is further improved.

Refer to FIG. 9, FIG. 9 is a flowchart of a second preferred embodiment of a method for modifying a webpage according to the present disclosure. The method for modifying a webpage of this preferred embodiment may be executed by using the second preferred embodiment of the foregoing apparatus 40 for modifying a webpage, and the method for modifying a webpage includes:

Step S901: Receive a webpage activation instruction, and acquire source code of a current webpage from a web server according to the webpage activation instruction.

Step S902: Parse the source code of the current webpage, and acquire webpage objects of the current webpage.

Step S903: Receive a webpage modification instruction, and modify a webpage object, corresponding to the webpage modification instruction, of the current webpage according to the webpage modification instruction.

Step S904: Receive an end-of-modification instruction, and modify the source code of the current webpage according to the end-of-modification instruction by using the webpage object after the modification of the current webpage.

Specific procedures of steps in the method for modifying a webpage of this preferred embodiment are described in detail below.

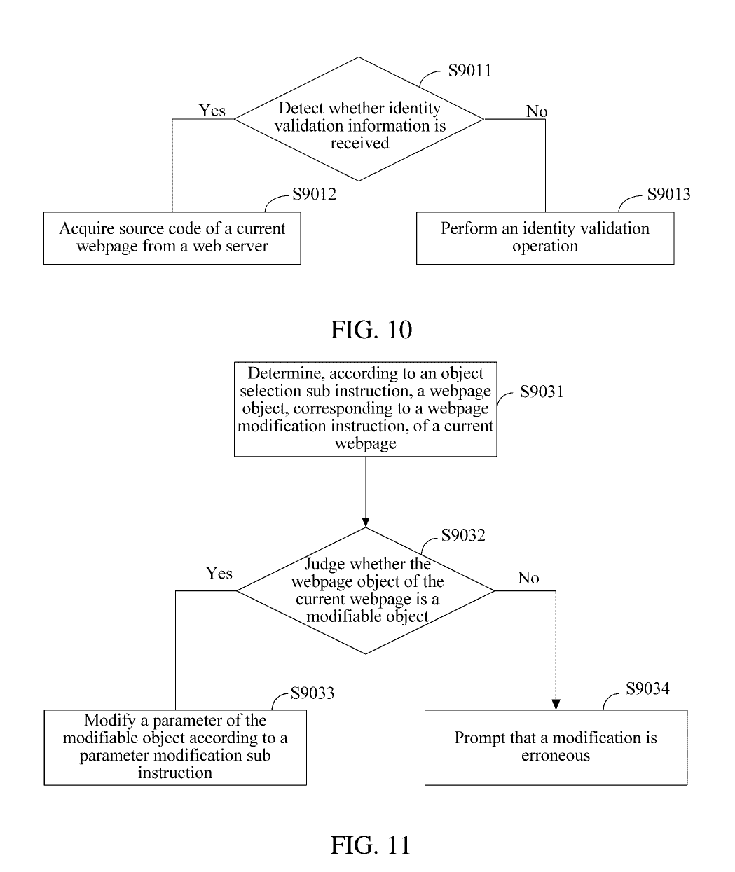

Refer to FIG. 10, FIG. 10 is a specific flowchart of step S901 in the second preferred embodiment of the method for modifying a webpage according to the present disclosure. Step S901 includes:

Step S9011: Detect whether identity validation information is received, and if the identity validation information is received, go back to step S9012; or else, go back to step S9013.

Step S9012: Acquire source code of the current webpage from the web server.

Step S9013: Perform an identity validation operation.

In step S9011, when a source code acquisition module 41 receives the webpage activation instruction, an identity information detection unit 411 of the source code acquisition module 41 detects whether a client receives the identity validation information input by a user. If the identity validation information is received, go back to step S9012; or else, go back to step S9013.

In step S9012, if the identity information detection unit 411 acquires the identity validation information (for example, login account information, where the login account information has a permission for modifying a webpage) of the user, a source code acquisition unit 412 of the source code acquisition module 41 acquires source code of a current webpage 46 from a web server 47, to modify the source code of the current webpage 46. Subsequently, go to step S904.

In step S9013, if the identity information detection unit 411 does not acquire the identity validation information of the user, an identity validation unit 413 of the source code acquisition module 41 performs the identity validation operation, for example, a user login interface pops up to prompt the user to input the identity validation information.

In step S902, a webpage parsing module 42 parses the source code, which is acquired by the source code acquisition module 41, of the current webpage 46, and acquires webpage objects of the current webpage 46. If the source code of the current webpage 46 is parsed into a DOM tree, the webpage objects of the current webpage 46 are element objects (or nodes) on the DOM tree. The parsed webpage objects of the current webpage 46 may be viewed by a user in a visual manner.

Refer to FIG. 11, FIG. 11 is a specific flowchart of step S903 in the second preferred embodiment of the method for modifying a webpage according to the present disclosure, and step S903 includes:

Step S9031: Determine, according to an object selection sub instruction, a webpage object, corresponding to the webpage modification instruction, of the current webpage.

Step S9032: Judge whether the webpage object, corresponding to the webpage modification instruction, of the current webpage is a modifiable object according to a name and an attribute of the webpage object of the current webpage; and if the webpage object is a modifiable object, go back to step S9033; or if the webpage object is not a modifiable object, go back to step S9034.

Step S9033: Modify a parameter of the modifiable object according to a parameter modification sub instruction.

Step S9034: Prompt that a modification is erroneous.

In step S9031, when a webpage modification module 43 receives the webpage modification instruction, a webpage object determining unit 431 of the webpage modification module 43 determines, according to the object selection sub instruction in the webpage modification instruction, the webpage object (for example, an element object of the DOM tree), corresponding to the webpage modification instruction, of the current webpage 46. Subsequently, go to step S9032.

In step S9032, a webpage object judging unit 432 judges whether the webpage object, corresponding to the webpage modification instruction, of the current webpage 46 is a modifiable object according to the name and the attribute of the webpage object of the current webpage. For example, the user may set that an element object whose name is A or B and attribute is inline-block is a modifiable object, or the like. If the webpage object is a modifiable object, go to step S9033; or if the webpage object is not a modifiable object, go to step S9034.

In step S9033, if the webpage object selected by the user is a modifiable object, the webpage modification unit 433 modifies the parameter of the modifiable object according to the parameter modification sub instruction in the webpage modification instruction, and the parameter of the modifiable object may be a setting parameter such as content, a color, and a font of the modifiable object.

Preferably, herein, the modifying, by the webpage modification unit 433, a parameter of the modifiable object according to the parameter modification sub instruction may specifically be that: a display area determining subunit 4331 of the webpage modification unit 433 determines a display area of the modifiable object, and a webpage modification subunit 4332 of the webpage modification unit 433 modifies, in the display area of the modifiable object, the parameter of the modifiable object according to the parameter modification sub instruction. Because the display area determining subunit 4332 displays a modification range, availability of modification is further improved in this way, so that the user is prevented from modifying out of the range easily. A mask setting subunit 4333 of the webpage modification unit 433 sets a mask in a non-display area of the modifiable object, to avoid erroneously modifying a parameter of another webpage object. Subsequently, go to step S904.

In step S9034, if the webpage object selected by the user is not a modifiable object, an erroneous prompt unit 434 prompts that a modification is erroneous, to inform the user that the webpage object is unmodifiable.

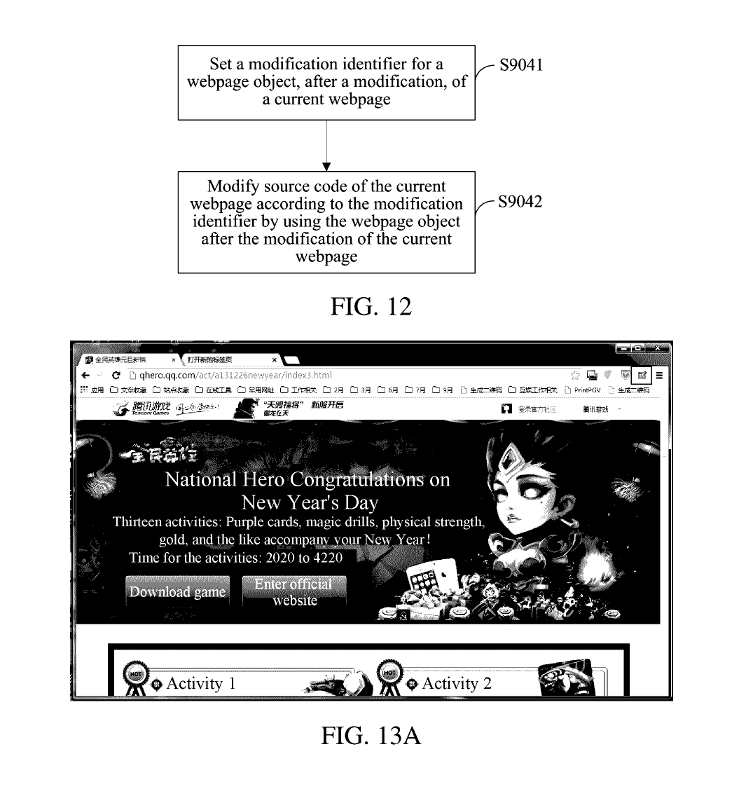

Refer to FIG. 12, FIG. 12 is a specific flowchart of step S904 in the second preferred embodiment of the method for modifying a webpage according to the present disclosure, and step S904 includes:

Step S9041. Set a modification identifier for the webpage object after the modification of the current webpage.

Step S9042: Modify the source code of the current webpage according to the modification identifier by using the webpage object after the modification of the current webpage.

In step S9041, a modification identifier setting unit 441 of a source code modification module 44 sets the modification identifier for the webpage object after the modification of the current webpage 46 (for example, regular expressions are generated for all the webpage objects after the modification of the current webpage 46), to distinguish all the webpage objects after the modification of the current webpage 46. In this way, a modification error does not occur even if webpage objects having same content are modified. Subsequently, go to step S9042.

In step S9042, after the setting of the modification identifier is finished, a source code modification unit 442 of the source code modification module 44 modifies, by using the webpage object after the modification of the current webpage 26, the source code of the current webpage 26 according to the modification identifier set by the modification identifier setting unit 441.

In this way, a process of modifying the webpage in the method for modifying a webpage of this preferred embodiment is completed.

Preferably, the method for modifying a webpage of this preferred embodiment may further include:

Step S905. Upload the source code after the modification of the current webpage to the web server, to overwrite the source code before the modification of the current webpage.

In step S905, an upload module 45 of the apparatus 40 for modifying a webpage uploads the source code after the modification of the current webpage 46 to the web server 47, and overwriting may be performed on the source code before the modification of the current webpage 46 if a manager agrees.

The detecting of identity information is added, based on the first preferred embodiment, in the method for modifying a webpage of this preferred embodiment, so that a process of modifying a webpage is optimized, and a modification identifier is set, so that processing efficiency of a webpage modification operation is further improved.

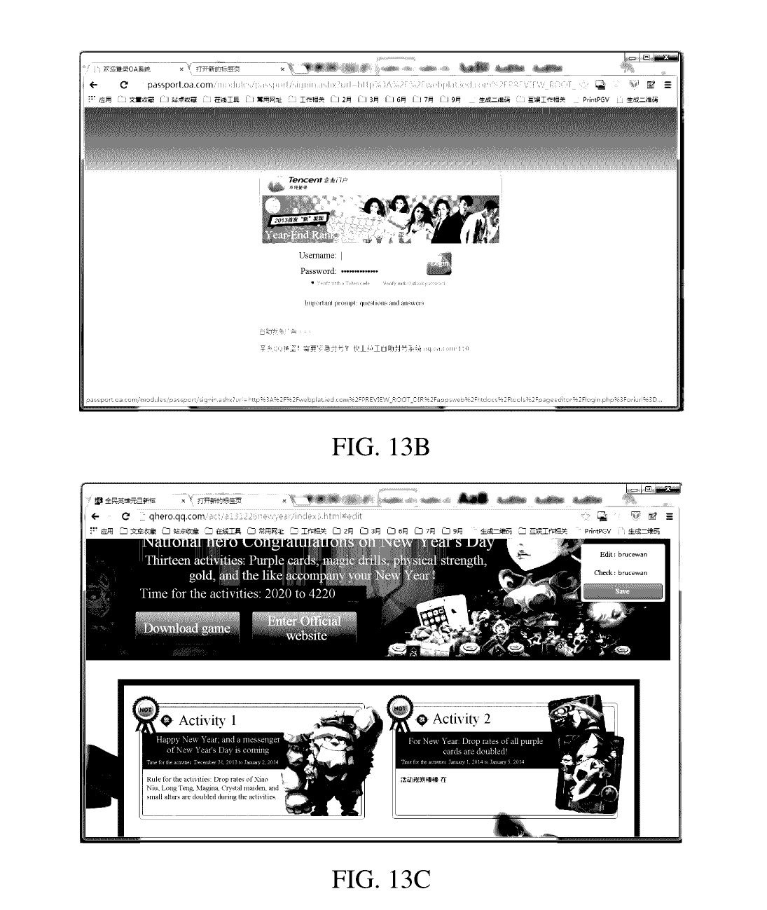

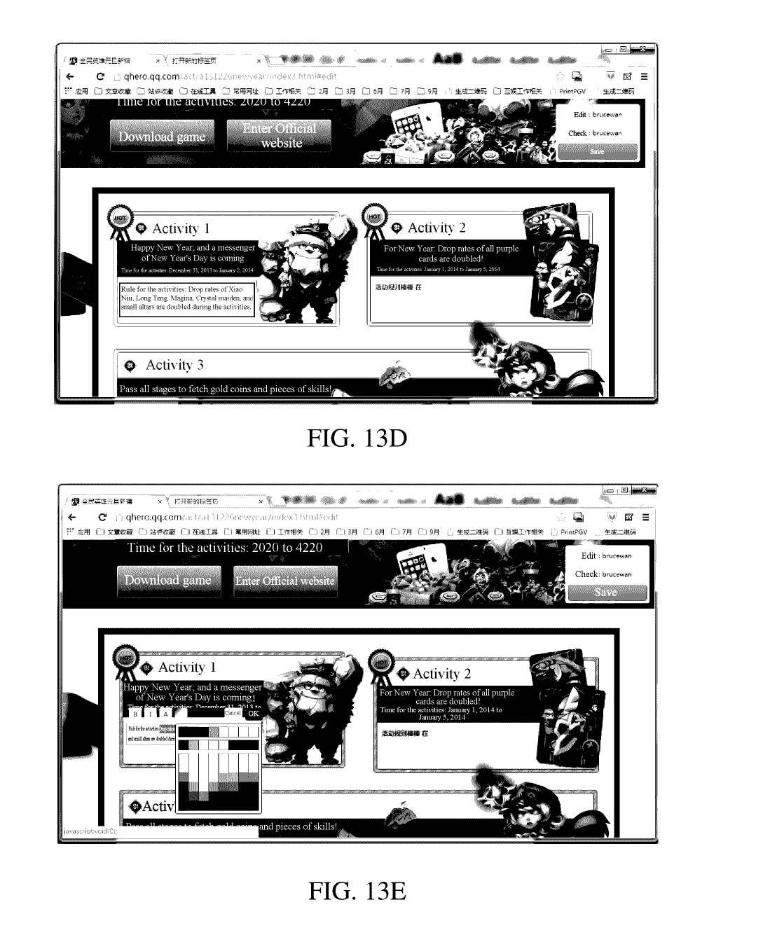

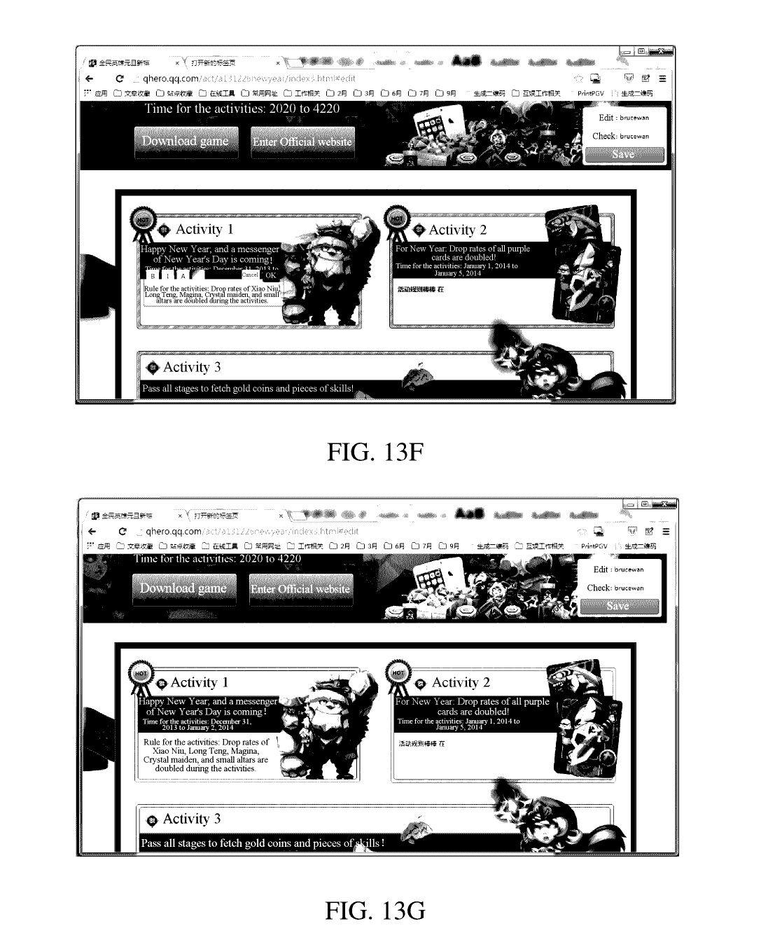

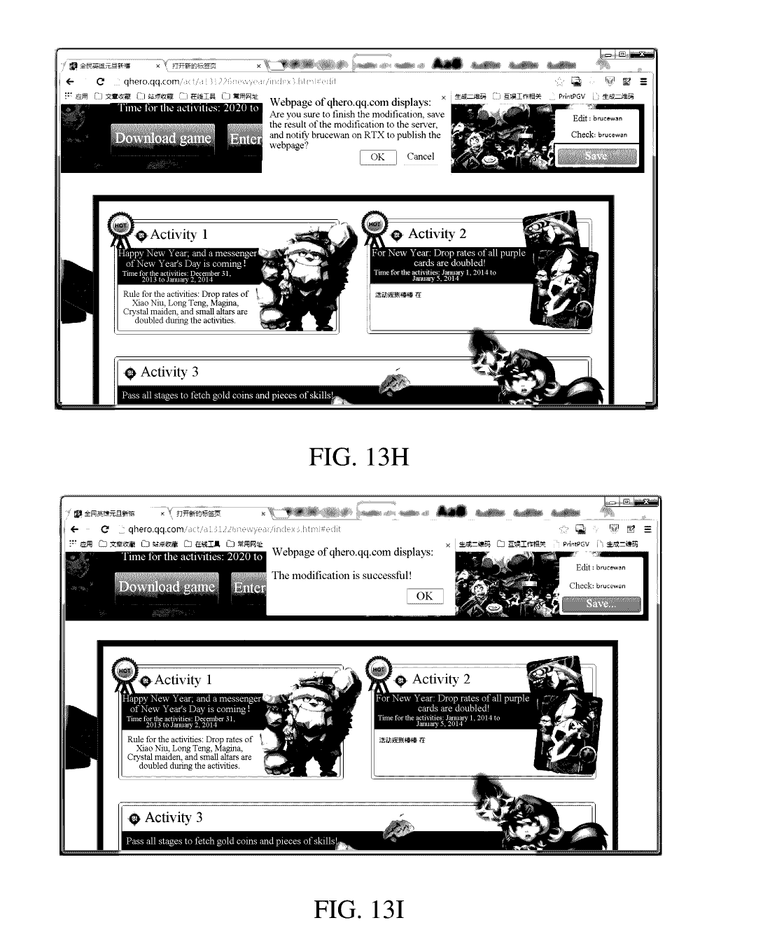

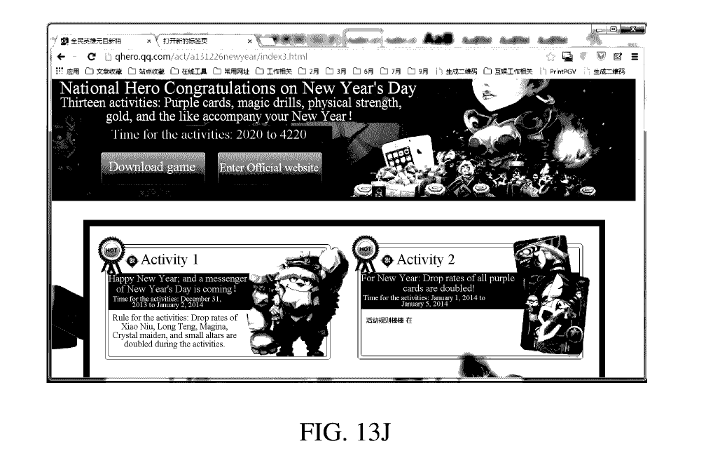

Specific working principles of the method for modifying a webpage and the apparatus for modifying a webpage of the present disclosure are described below by using a specific embodiment. Refer to FIG. 13A-FIG. 13J, FIG. 13A-FIG. 13J are schematic diagram of usage of a method for modifying a webpage and an apparatus for modifying a webpage according to the present disclosure.

1. A user opens a webpage to be edited by using an apparatus for modifying a webpage (which may be provided on a browser of a client) on a client, and clicks an icon (as shown in an upper right corner of FIG. 13A) of a plug-in.

2. The apparatus for modifying a webpage detects whether the user logs in, and displays a login page if the user does not logs in, so as to perform an identity validation operation on the user, which is specifically shown in FIG. 13B.

3. After the user successfully logs in, the apparatus for modifying a webpage requests source code of a current webpage from a web server, and parses the source code into a DOM tree, so that element objects on the DOM tree are provided in a visual manner for the user to view, and in this case, the current page enters an editable state, which is shown in FIG. 13C.

4. The user selects, by using the apparatus for modifying a webpage, a webpage object (an element object of the DOM tree) of the current webpage for modification. In this case, the apparatus for modifying a webpage judges whether the webpage object is a modifiable object according to a name and an attribute of the webpage object, for example, a public navigation section of a webpage is generally set to being unmodifiable (for example, a public navigation section of a webpage is generally set to content dynamically generated by using Javascript). It is set herein that the user selects a part in a left box in FIG. 13 for modification, and webpage objects corresponding to the part are modifiable objects.

5. After the modifiable object is selected, the apparatus for modifying a webpage opens a toolbar used for editing a webpage, allows the user to modify a setting parameter such as content, a color, a font, a size, a hyperlink, italic, bold, and a position of an area of the modifiable object, and further sets a mask in a non-display area of the modifiable object to avoid an erroneous modification of a parameter of another webpage object, which are specifically shown in FIG. 13E.

If the user selects text in the modifiable objects by using the apparatus for modifying a webpage, the user may directly input, by using the toolbar for editing a webpage, corresponding text into the display area, and after the modification is finished, the user clicks a validation button, and saves a result of the modification operation, which are specifically shown in FIG. 13F. The modifiable object after the modification is shown in FIG. 13G.

6. During a process of modifying the webpage object, the apparatus for modifying a webpage sets a corresponding modification identifier (not visible to the user) for the webpage object, for example, the apparatus for modifying a webpage generates a regular expression according to the modified webpage object (the element object of the DOM tree), and performs regular matching to distinguish all webpage objects after the modification of the current webpage. In this way, a modification error does not occur even if webpage objects having same content are modified.

7. After the modification of the current webpage is finished, the user clicks a save button (sends an end-of-modification instruction), and the apparatus for modifying a webpage modifies the source code of the current webpage by using the webpage object after the modification of the current webpage, and saves the result of the modification, which are specifically shown in FIG. 13H and FIG. 13I.

8. The apparatus for modifying a webpage uploads the source code after the modification of the current webpage to the web server, and notifies a webpage manager to publish the webpage. The published webpage is shown in FIG. 13J.

In this way, an entire process of modifying the webpage is completed.

In the method for modifying a webpage and the apparatus for modifying a webpage of the present disclosure, source code of a webpage is converted into a webpage object, thereby implementing a visual modification for a webpage; and solving technical problems such as low efficiency of a modification operation and modification processing in an existing apparatus for modifying a webpage and an existing method for modifying a webpage.

Functional units in the embodiments of the present invention may be integrated into one processing module, or each of the units may exist alone physically, or two or more units are integrated into one module. The integrated module may be implemented in the form of hardware, or may be implemented in the form of a software functional module. When the integrated module is implemented in the form of a software functional module and sold or used as an independent product, the integrated unit may also be stored in a computer-readable storage medium. The storage medium mentioned above may be an ROM, a magnetic disk, an optical disc, or the like. The methods in the corresponding method embodiments may be executed by the foregoing apparatuses and system.

In summary, although the present disclosure has been disclosed above through the preferred embodiments, the preferred embodiments are not intended to limit the present disclosure. A person of ordinary skills in the art can make some various variations or modifications without departing from the spirit and the scope of the present disclosure. Therefore, the protection scope of the present disclosure shall be subject to the scope defined by the claims.

What is claimed is:

1. A method for modifying a webpage, comprising:
receiving a webpage activation instruction, and acquiring source code of a current webpage from a web server according to the webpage activation instruction;
parsing the source code of the current webpage, and acquiring and displaying webpage objects of the current webpage, the webpage objects comprising modifiable objects;
receiving a webpage modification instruction, and modifying a modifiable object of the current webpage according to the webpage modification instruction, the modifiable object of the current webpage corresponding to the webpage modification instruction; and
receiving an end-of-modification instruction, and modifying the source code of the current webpage according to the end-of-modification instruction by using the modifiable object after the modification.

2. The method for modifying a webpage according to claim 1, wherein the step of acquiring source code of a current webpage from a web server comprises:
detecting whether identity validation information is received; and
acquiring, if the identity validation information is received, the source code of the current webpage; or performing, if the identity validation information if not received, an identity validation operation.

3. The method for modifying a webpage according to claim 1, wherein the webpage modification instruction comprises an object selection sub instruction and a parameter modification sub instruction; and
the step of modifying a modifiable object of the current webpage according to the webpage modification instruction comprises:
determining, according to the object selection sub instruction, a webpage object, corresponding to the webpage modification instruction, of the current webpage;
judging whether the webpage object, corresponding to the webpage modification instruction, of the current webpage is a modifiable object according to a name and an attribute of the webpage object of the current webpage; and
modifying, if the webpage object, corresponding to the webpage modification instruction, of the current webpage is a modifiable object, a parameter of the modifiable object according to the parameter modification sub instruction; otherwise, prompting that a modification is erroneous.

4. The method for modifying a webpage according to claim 3, wherein the step of modifying a parameter of the modifiable object according to the parameter modification sub instruction comprises:
determining a display area of the modifiable object; and
modifying, in the display area of the modifiable object, the parameter of the modifiable object according to the parameter modification sub instruction.

5. The method for modifying a webpage according to claim 3, wherein the step of modifying a parameter of the modifiable object according to the parameter modification sub instruction comprises:
setting a mask in a non-display area of the modifiable object, to distinguish a display area of the modifiable object from the non-display area of the modifiable object.

6. The method for modifying a webpage according to claim 1, wherein the step of modifying the source code of the current webpage by using the webpage object after the modification of the current webpage comprises:
setting a modification identifier for the webpage object after the modification of the current webpage; and
modifying the source code of the current webpage according to the modification identifier by using the webpage object after the modification.

7. The method for modifying a webpage according to claim 1, wherein the method for modifying a webpage comprises:
uploading the source code after the modification of the current webpage to the web server, to overwrite the source code before the modification of the current webpage.

8. An apparatus for modifying a webpage, comprising at least one processor and a memory, the memory stores computer-readable instructions executable by the at least one processor to:
receive a webpage activation instruction, and acquire source code of a current webpage from a web server according to the webpage activation instruction;
parse the source code of the current webpage, and acquire and display webpage objects of the current webpage, the webpage objects comprising modifiable objects;
receive a webpage modification instruction, and modify a modifiable object of the current webpage according to the webpage modification instruction, the modifiable object of the current webpage corresponding to the webpage modification instruction; and
receive an end-of-modification instruction, and modify the source code of the current webpage according to the end-of-modification instruction by using the modifiable object after the modification of the current webpage.

9. The apparatus according to claim 8, wherein the computer-readable instructions are executable by the at least one processor to:
detect whether identity validation information is received;
acquire the source code of the current webpage from the web server; and
an identity validation unit, configured to perform an identity validation operation.

10. The apparatus for modifying a webpage according to claim 8, wherein the computer-readable instructions executable by the at least one processor to:
determine, according to the object selection sub instruction, a webpage object, corresponding to the webpage modification instruction, of the current webpage;
judge whether the webpage object, corresponding to the webpage modification instruction, of the current webpage is a modifiable object according to a name and an attribute of the webpage object of the current webpage;
modify a parameter of the modifiable object according to the parameter modification sub instruction; and
prompt that a modification is erroneous.

11. The apparatus for modifying a webpage according to claim 10, wherein the computer-readable instructions executable by the at least one processor to:
determine a display area of the modifiable object; and
modify, in the display area of the modifiable object, the parameter of the modifiable object according to the parameter modification sub instruction.

12. The apparatus for modifying a webpage according to claim 10, wherein the computer-readable instructions executable by the at least one processor to:
set a mask in a non-display area of the modifiable object, distinguish a display area of the modifiable object from the non-display area of the modifiable object.

13. The apparatus according to claim 8, wherein the computer-readable instructions executable by the at least one processor to:
set a modification identifier for the webpage object after the modification of the current webpage; and
modify the source code of the current webpage according to the modification identifier by using the webpage object after the modification.

14. The apparatus for modifying a webpage according to claim 8, wherein the computer-readable instructions executable by the at least one processor to:
upload the source code after the modification of the current webpage to the web server, to overwrite the source code before the modification of the current webpage.

15. A computer-readable storage medium, comprising computer-readable instructions executable by a processor to:
receive a webpage activation instruction, and acquire source code of a current webpage from a web server according to the webpage activation instruction;
parse the source code of the current webpage, and acquire and display webpage objects of the current webpage, the webpage objects comprising modifiable objects;
receive a webpage modification instruction, and modify a modifiable object of the current webpage according to the webpage modification instruction, the modifiable object of the current webpage corresponding to the webpage modification instruction; and
receive an end-of-modification instruction, and modify the source code of the current webpage according to the end-of-modification instruction by using the modifiable object after the modification of the current webpage.

16. The storage medium according to claim 15, wherein the computer-readable instructions are executable by the processor to:
detect whether identity validation information is received;
acquire the source code of the current webpage from the web server; and
an identity validation unit, configured to perform an identity validation operation.

17. The storage medium according to claim 15, wherein the computer-readable instructions executable by the processor to:
determine, according to the object selection sub instruction, a webpage object, corresponding to the webpage modification instruction, of the current webpage;
judge whether the webpage object, corresponding to the webpage modification instruction, of the current webpage is a modifiable object according to a name and an attribute of the webpage object of the current webpage;
modify a parameter of the modifiable object according to the parameter modification sub instruction; and
prompt that a modification is erroneous.

18. The storage medium according to claim 17, wherein the computer-readable instructions executable by the processor to:
determine a display area of the modifiable object; and
modify, in the display area of the modifiable object, the parameter of the modifiable object according to the parameter modification sub instruction.

19. The apparatus according to claim 15, wherein the computer-readable instructions executable by the processor to:
set a modification identifier for the webpage object after the modification of the current webpage; and
modify the source code of the current webpage according to the modification identifier by using the webpage object after the modification.

20. The storage medium according to claim 15, wherein the computer-readable instructions executable by the processor to:
upload the source code after the modification of the current webpage to the web server, to overwrite the source code before the modification of the current webpage.
